(19) United States
(12) Patent Application Publication
(10) Pub. No.: US 2006/0238053 A1
(43) Pub. Date: Oct. 26, 2006

(54) Conical bearingless motor/generator

(75) Inventors: Peter E. Kascak, Grafton, OH (US); Ralph H. Jansen, Grafton, OH (US); Timothy P. Dever, Westlake, OH (US)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: The University of Toledo

(21) Appl. No.: 11/451,927

(22) Filed: Jun. 13, 2006

Related U.S. Application Data
(63) Continuation-in-part of application No. 11/068,509, filed on Feb. 28, 2005.
(63) Continuation-in-part of application No. 11/304,359, filed on Dec. 15, 2005.
(60) Provisional application No. 60/637,280, filed on Dec. 17, 2004.
(60) Provisional application No. 60/548,894, filed on Mar. 1, 2004.

(51) Int. Cl. H02K 7/09

(52) U.S. Cl. 310/90.5

(57) ABSTRACT

A bearingless motor/generator comprises a rotatable part and a stationary part. The rotatable part is adapted to be rotated about an axis of rotation with respect to the stationary part. The stationary part has one or more windings for producing a drive field and a control field. The drive field is adapted to exert a torque on the rotatable part to transfer energy between the rotatable part and the stationary part. The control field is adapted to exert a force on the rotatable part to levitate the rotatable part. The force is adapted to be directed at an angle greater than 0° and less than 90° relative to the axis of rotation of the rotatable part.

### CROSS REFERENCE TO RELATED APPLICATIONS

This application a continuation-in-part of U.S. patent application Ser. No. 11/068,509, filed on Feb. 28, 2005, and U.S. patent application Ser. No. 11/304,359, filed on Dec. 15, 2005, the descriptions of which are incorporated herein by reference.

This invention was made with government support under NCC3-916 and NCC3-924 awarded by NASA. The government has certain right in the invention.

### BACKGROUND OF INVENTION

The present invention generally relates to an electromagnetic rotary drive and more particularly, to an electromagnetic rotary drive that functions as a bearingless motor/generator. The invention also relates to a control system for a bearingless motor-generator.

Electromagnetic rotary drives are commonly used in standard motors as well as bearingless motor-generators. Conventional bearingless motor/generators are commonly used in flywheels, turbines, pumps and machine tools. Bearingless motor/generators typically include an electromagnetic rotary drive having a rotary part and a stationary part. The rotary part is commonly referred to as a rotor and the stationary part is commonly referred to as a stator. The stator supports a set of windings, including a drive winding for producing a drive field and a separate control winding for producing a control field. The drive field exerts a torque on the rotor that transfers energy between the rotor and the stator, and the control field exerts a force on the rotor to levitate the rotor.

A conventional control system for an electromagnetic rotary drive for a standard motor is shown in FIG. 1. The control system, generally indicated at 10, includes six switches 12, which control the flow of phase currents into a set of windings to produce forces, which exert a torque on a rotating part. However, this control system produces no forces for levitating the rotating part, since poles carry the same flux, and balance their forces out.

Unlike the standard motor described above, a conventional bearingless motor-generator produces forces for levitating the rotating part. Conventional bearingless motor/generators function to exert radial levitation, in the case of a radial gap machine, or axial levitation, in the case of an axial gap machine. In a radial levitation machine, additional elements are required to provide axial control of the rotor. Similarly, in an axial levitation machine, additional elements are required to provide radial control of the rotor. These additional elements increase the cost, size and weight of the machines.

An example of a bearingless motor-generator is described in U.S. Pat. No. 6,559,567, issued May 6, 2003, to Schöb, the description of which is incorporated herein by reference. This bearingless motor-generator has a control system for an electromagnetic rotary drive that includes control devices, which control the flow of phase currents into two windings. The phase currents have a mutual phase shift of about 120°. The control system produces forces transverse to the windings. These transverse forces can be repulsive forces or attractive forces. By orienting the windings as described by Schöb, the forces may be directed at an angle greater than 0° and less than 90° relative to the axis of rotation of the rotor. In this way, the rotor can be axially or radially levitated.

It should be noted that the bearingless motor-generator described above includes a drive winding for producing a drive field and a separate control winding for producing a control field. The drive field exerts a torque on the rotating part to rotate the rotating part and the control field exerts a force on the rotating part to levitate the rotating part.

A bearingless motor/generator is needed that minimizes elements required for driving and controlling the rotor and thus decreases the cost, size and weight of bearingless machines.

A control system is also needed that permits both drive and control fields to be produced from the same set of windings, thus eliminating the need to separate drive and control windings.

### SUMMARY OF INVENTION

The present invention is directed towards a bearingless motor/generator that meets the foregoing needs. The bearingless motor/generator comprises a rotatable part and a stationary part. The rotatable part is adapted to be rotated about an axis of rotation with respect to the stationary part. The stationary part has one or more windings for producing a drive field and a control field. The drive field is adapted to exert a torque on the rotatable part to transfer energy between the rotatable part and the stationary part. The control field is adapted to exert a force on the rotatable part to levitate the rotatable part. The force is adapted to be directed at an angle greater than 0° and less than 90° relative to the axis of rotation of the rotatable part. In this way, the rotatable part can be axially and radially levitated without of additional elements.

### BRIEF DESCRIPTION OF DRAWINGS

FIG. 1 is schematic representation of a motor drive system according to the prior art.

FIG. 2 is a partially cutaway perspective view of a conical bearingless motor/generator according to a first embodiment of the present invention.

FIG. 3 is a diagrammatic representational view in cross-section of the conical bearingless motor/generator illustrated in FIG. 2.

FIG. 4 is a diagrammatic representational view in cross-section of a conical bearingless motor/generator according to a second embodiment of the present invention.

FIG. 5 is a diagrammatic representational view of a sequence of control forces that could be produced by the conical bearingless motor/generator.

FIG. 6 in a diagrammatic cross-sectional view of the conical bearingless motor/generator taken along the line 5-5 in FIG. 5.

FIG. 7 is a partially cutaway perspective view of a bearingless machine having two conical bearingless motor/generators according to the present invention.

FIG. 8 is a diagrammatic representational view in cross-section of the bearingless machine illustrated in FIG. 7.

FIG. 9 is a diagrammatic representational view of a sequence of control forces that could be produced by a pair of the conical bearingless motor/generators.

FIG. 10 is a diagrammatic representational view in cross-section of a second embodiment of a bearingless machine having two conical bearingless motor/generators according to the present invention.

FIG. 11 is a diagrammatic representational view in cross-section of a third embodiment of a bearingless machine having two conical bearingless motor/generators according to the present invention.

FIG. 12 is a diagrammatic representational view in cross-section of a fourth embodiment of a bearingless machine having two conical bearingless motor/generators according to the present invention.

FIG. 13 is a diagrammatic representation in cross-section of a bearingless machine having three conical bearingless motor/generators according to the present invention.

FIG. 14 is a diagrammatic representational view in cross-section of a bearingless machine having a single conical bearingless motor/generator according to the present invention.

FIG. 15 is schematic representation of a cylindrical motor drive control system according to one embodiment of the invention.

FIG. 16 is a diagrammatic representation of a winding with individually stimulated pole pairs.

FIG. 17 is a schematic representation of stator induced flux in a rotor reference frame.

FIG. 18 is a graphic representation of force induced from pole pair d-axis current.

FIG. 19 is a graphic representation of a force magnitude.

FIG. 20 is a graphic representation of force components.

FIG. 21 is a graphic representation of phases of induced force by different pole pairs.

FIG. 22 is a diagrammatic representation of force vectors.

FIG. 23 is a graphic representation of force commands.

FIG. 24 is a graphic representation of rotor levitation.

FIG. 25 is a graphic representation of x-position during levitation.

FIG. 26 is a graphic representation of force command components.

FIG. 27 is a graphic representation of phase currents in three different pole pairs during a levitation period with a 10 A rotor reference frame q-axis current.

FIG. 28 is a graphic representation of levitation off a back-up bearing.

FIG. 29 is a graphic representation of phase currents in three different pole pairs during a levitation period with a 50 A rotor reference frame q-axis current.

FIG. 30 is a perspective view of a conical motor driven by conical motor drive control system according to one embodiment of the invention.

FIG. 31 is a sectional perspective view of the conical motor shown in FIG. 30.

FIG. 32 is a sectional elevation view of the conical motor shown in FIG. 30.

FIG. 33 is a schematic representation of a conical motor drive control system according to one embodiment of the invention.

FIG. 34 is a diagrammatic representation of force vectors.

FIG. 35 is a schematic representation of a force generation control code.

FIG. 36 is a schematic representation of an axial force control block.

FIG. 37 is a schematic representation of a control circuit for the conical motor drive control system.

FIG. 38 is a schematic representation of an implementation of a position controller as a proportional-integral-derivative (PID) controller.

### DETAILED DESCRIPTION

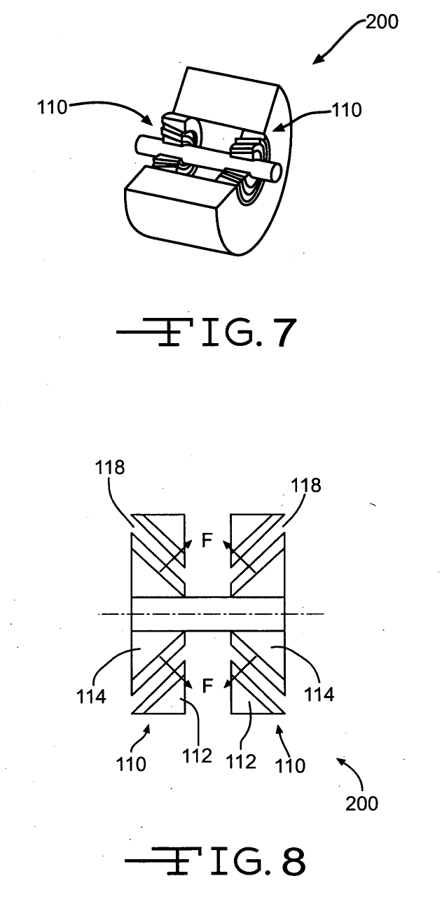

Referring now to the drawings, there is illustrated in FIGS. 3 and 4 a conical bearingless motor/generator, generally indicated at 110, according to a first embodiment of the invention. The term “motor/generator” should be clearly understood to mean that the conical bearingless motor/generator is adapted to function as either a motor or a generator. The conical bearingless motor/generator 110 comprises a rotatable part 112 and a stationary part 114. The rotatable part 112 is adapted to be rotated about an axis of rotation A (shown in FIG. 3) and with respect to the stationary part 114. The stationary part 114 has one or more windings 116 for producing both a drive field and a control field. The drive field is adapted to exert a torque on the rotatable part 112 that transfers energy between the rotatable part 112 and the stationary part 114.

As illustrated in FIG. 3, the control field is adapted to exert a force F on the rotatable part 112 to levitate the rotating part 112 with respect to the stationary part 114. The winding 116 is oriented so that the force F is directed at an angle, which is greater than 0° and less than 90° relative to the axis of rotation A of the rotatable part 112. In this way, the control field can axially and radially levitate the rotatable part 112. This levitation results in an angular air gap 118 between the rotatable part 112 and the stationary part 114. It should be appreciated that the angle of the force F may be dependent on the application of the conical bearingless motor/generator 110.

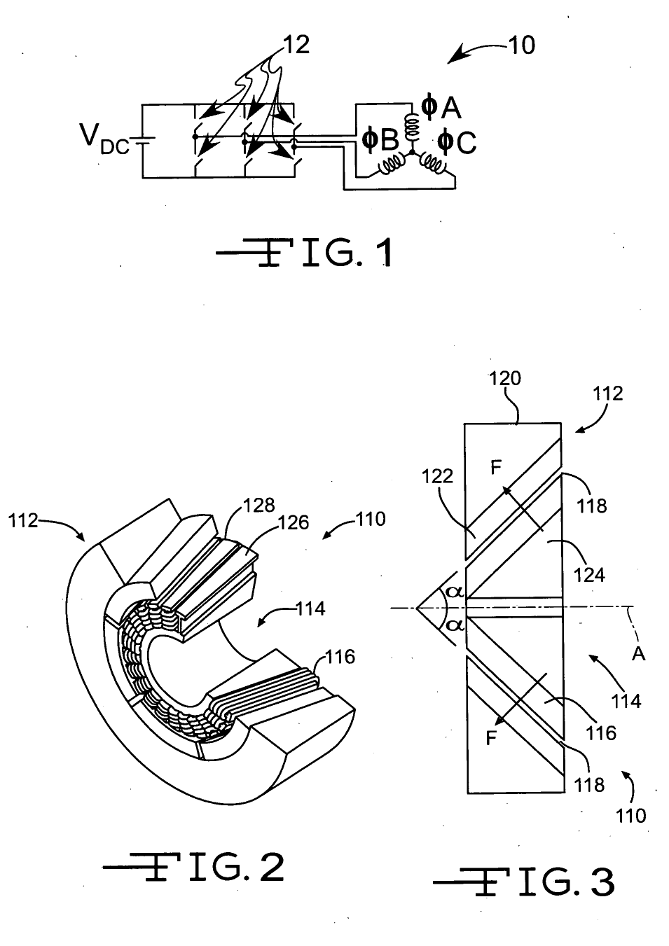

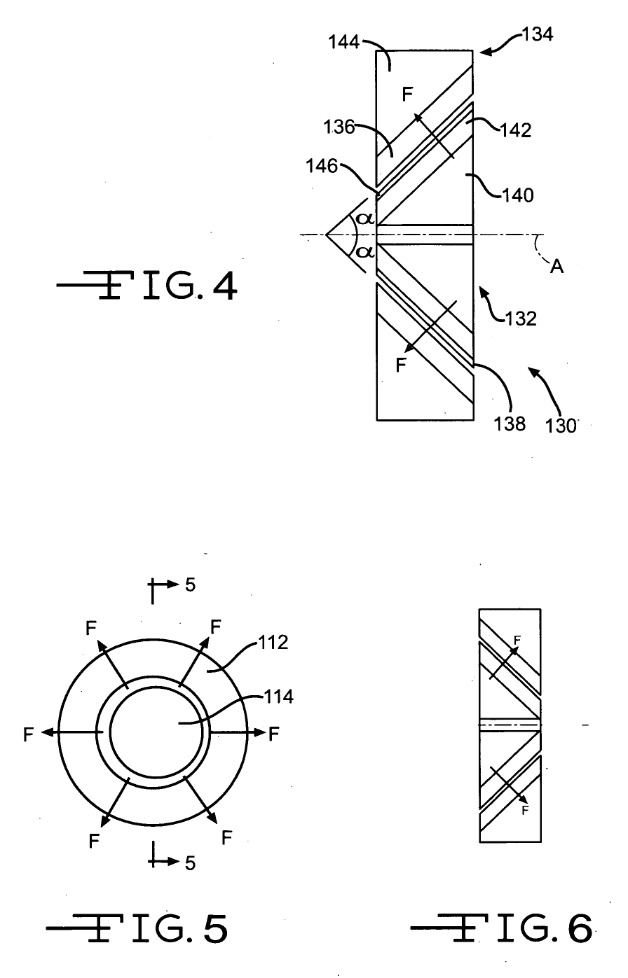

The rotatable part 112 may include a soft magnetic and/or non-magnetic structure 120, such as a back iron, and a hard magnetic structure 122, such as a permanent magnet, supported with respect to the soft magnetic and/or non-magnetic structure 120. The stationary part 114 may likewise include a soft magnetic and/or non-magnetic structure 124, such as a back iron. Teeth 126 and slots 128 (shown in FIG. 2) may be supported relative to the soft magnetic and/or non-magnetic structure 124. The teeth 126 and slots 128 support the winding 116. In addition, the teeth distribute the flux in conical bearingless motor/generator 110. Alternatively, the winding 116 may be affixed relative to the soft magnetic and/or non-magnetic structure 124 in some other suitable manner, such as with epoxy. In this case, teeth 126 and slots 128 are not required. The soft magnetic and/or non-magnetic structures 120, 124 each may include a portion that is tapered at the angle a relative to the axis of rotation A of the rotatable part 112 to hold the hard magnetic structure 122 and the winding 116 substantially parallel to one another. The angle of the force F exerted by the control field is preferably orthogonal to the angle a of the tapered portions of the rotatable part 112 and stationary part 114. The illustrated force F is a repulsive force that pushes the rotatable part 112 in a direction away from the stationary part 114. However, it should be appreciated that the force F exerted by the control field may alternatively be an attractive force to pull the rotatable part 112 in a direction towards the stationary part 114.

A second embodiment of the conical bearingless motor/generator 130 is illustrated in FIG. 4, wherein a rotatable part 132 is situated within a stationary part 134, converse to that the first embodiment described above. The rotatable part 132 is adapted to be rotated about an axis of rotation A and with respect to the stationary part 134. The stationary part 134 has one or more windings 136 for producing both a drive field and a control field. The drive field is adapted to exert a torque on the rotatable part 32 that transfers energy between the rotatable part 132 and the stationary part 134. The control field is adapted to exert a force F on the rotatable part 132 to levitate the rotating part 132 with respect to the stationary part 134. The winding 136 is oriented so that the force F is directed at an angle, which is greater than 0° and less than 90° relative to the axis of rotation A of the rotatable part 132. In this way, the control field can axially and radially levitate the rotatable part 132. This levitation results in an angular air gap 138 between the rotatable part 132 and the stationary part 134. It should be appreciated that the angle of the force F may be dependent on the application of the conical bearingless motor/generator 130.

The rotatable part 132 may include a soft magnetic and/or non-magnetic structure 140, such as a back iron, and a hard magnetic structure 142, such as a permanent magnet, supported with respect to the soft magnetic and/or non-magnetic structure 140. The stationary part 134 may likewise include a soft magnetic and/or non-magnetic structure 144, such as a back iron. Teeth and slots (not shown) may be supported relative to the soft magnetic and/or non-magnetic structure 144 of the stationary part 134. The teeth and slots support the winding 136. Alternatively, the winding 136 may be affixed relative to the soft magnetic and/or non-magnetic structure 144 in some other suitable manner, such as with epoxy. The soft magnetic and/or non-magnetic structures 140, 144 each may include a portion that is tapered at the angle a relative to the axis of rotation A of the rotatable part 132 to hold the hard magnetic structure 142 and the winding 136 substantially parallel to one another. The angle of the force F exerted by the control field is preferably orthogonal to the angle α of the tapered portions of the rotatable part 132 and stationary part 134. The illustrated force F is an attractive force that pulls the rotatable part 132 in a direction towards the stationary part 134. However, it should be appreciated that the force F exerted by the control field may alternatively be a repulsive force that pushes the rotatable part 132 in a direction away from the stationary part 134.

The first embodiment described above has some advantages over the second embodiment. For example, the second embodiment may require a retaining material 146, such as a carbon material, for holding the magnetic material 142 in place relative to the rotatable part 132. However, centrifugal forces exerted upon the rotatable part 112 of the first embodiment could function to hold a hard magnetic structure 122 in place relative to the rotatable part 112, without the aid of a retaining material. The elimination of the retaining material could result in a narrower air gap 118 between rotatable part 112 and the stationary part 114 of the first embodiment. A narrower air gap 118 is beneficial in conical bearingless motor/generator 110 because it will provide greater torque and greater radial force capability.

The windings 116, 136 can be controlled by any suitable control scheme. One such control scheme is described in U.S. Pat. No. 6,559,567, issued May 6, 2003, to Schöb, the description of which is incorporated herein by reference. To simplify the description, this control scheme will be discussed only with regard to the first embodiment described above. The control scheme uses two windings. One of the windings produces a drive field, which may exert a torque on the rotatable part 112 that transfers energy to the rotatable part 112. The other winding produces a control field that may exert a force on the rotatable part 112 to levitate the rotatable part 112. The windings have loops through which phase currents flow. Control devices (not shown) feed the phase currents flowing into the winding loops. The phase currents have a mutual phase shift of about 120°. The control system, as applied to a two-winding conical bearingless motor according to the present invention, produces forces transverse to the windings, such as the repulsive forces F diagrammatically represented in FIGS. 5 and 6. It should be clearly understood that the forces F could alternatively be attractive forces. By orienting the windings as described with respect to the foregoing embodiments of the invention, the force F may be directed at an angle greater than 0° and less than 90° relative to the axis of rotation of the rotatable part 112. In this way, the rotatable part 112 can be axially and radially levitated without the need of additional elements. It should be appreciated that a different number of windings with phase currents having different phase shift could produce different forces than those illustrated in FIGS. 5 and 6.

The aforementioned control scheme is described merely for illustrative purposes. It should be clearly understood that other control systems, though not described or shown, may be suitable for carrying out the present invention. Similarly, the present invention is not intended to be limited to any particular winding configuration. It should be appreciated that any suitable winding configuration may be used for carrying out the invention.

In application, one or more conical bearingless motor/generators 110 may be used to provide a magnetic suspension and drive system for rotating equipment. Two conical bearingless motor/generators 110 are used in a bearingless machine 200 provided for illustrative purposes in FIG. 7. The illustrated bearingless machine 200 is in the form of a flywheel energy storage system. However, it should be appreciated that the bearingless machine may be in other forms, such as but not limited to a turbine, a pump, a machine tool, or the like. The bearingless machine 200 may have a pair of conical bearingless motor/generators 110, similar to the conical bearingless motor/generator 110 described above and illustrated in FIGS. 2 and 3. As diagrammatically illustrated in FIG. 8, the rotatable part 112 is adapted to rotate about the stationary part 114. The conical bearingless motor/generators 110 control the rotatable part 112 along six axes, five lateral axes and one torque axis, which are diagrammatically illustrated in FIG. 9. The conical bearingless motor/generators 110 are oppositely directed. Consequently, axial components of the forces F of the two conical bearingless motor/generators 110 can cooperatively control the axial position of the rotatable parts 112 of the conical bearingless motor/generators 110 to provide axial levitation. The two conical bearingless motor/generators 110 cooperatively reduce the number of elements required to levitate the rotatable parts 112. Moreover, since the conical bearingless motor/generators 110 take up less axial length, bending mode frequencies can be increased to improve rotordynamics and ease of control of the rotatable parts 112.

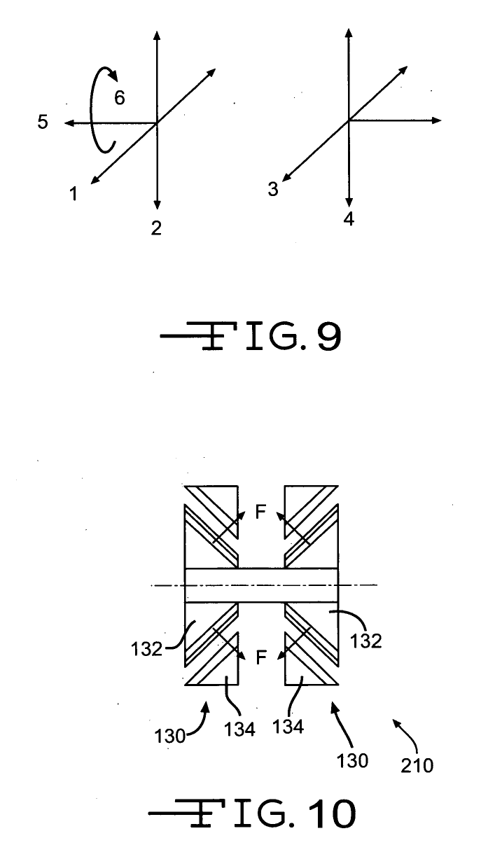

Alternative embodiments of bearingless machines are illustrated in FIGS. 10-13. A second embodiment of a bearingless machine 210 is illustrated in FIG. 10. This embodiment includes a pair of conical bearingless motor/generators 130 similar to the second embodiment described above and shown in FIG. 4. In this embodiment, rotatable parts 132 are adapted to rotate within stationary parts 134. The aforementioned first embodiment of the bearingless machine 200 has some advantages over this bearingless machine 210. For example, centrifugal forces exerted upon the rotatable parts 112 of the first embodiment could hold a hard magnetic structure (not shown) in place relative to the rotatable parts 112, without the aid of a retaining material (not shown). The elimination of the retaining material could result in narrower air gaps 118 between rotatable parts 112 and the stationary parts 114 (shown in FIG. 8).

A third embodiment of a bearingless machine 220 is illustrated in FIG. 11. In accordance with this embodiment, a pair of rotatable parts 152 is supported for rotation about a pair of stationary parts 154, similar to the first embodiment of the bearingless machine 200 described above. However, the rotatable parts 152 and stationary parts 154 are tapered in opposing directions to the rotatable parts 112 and stationary parts 114 in the first embodiment of the bearingless machine 200. This bearingless machine 220 has some advantages over the aforementioned bearingless machine 210. For example, centrifugal forces exerted upon the rotatable parts 152 could hold a hard magnetic structure (not shown) in place relative to the rotatable parts 152, eliminating the need for a retaining material (not shown). The elimination of the retaining material could result in narrower air gaps 158 between rotatable parts 152 and the stationary parts 154.

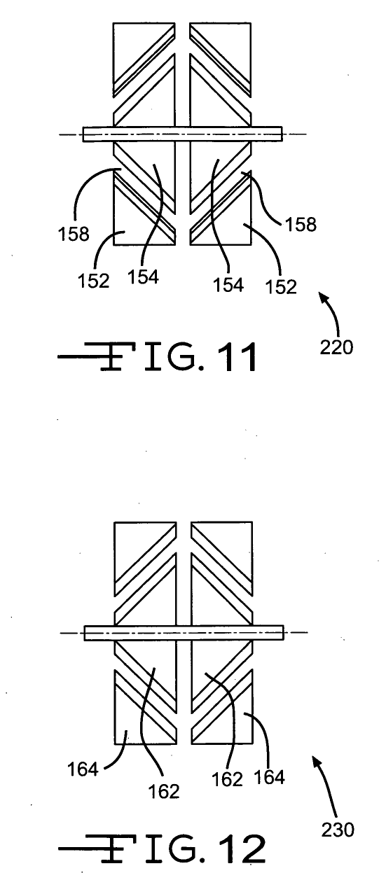

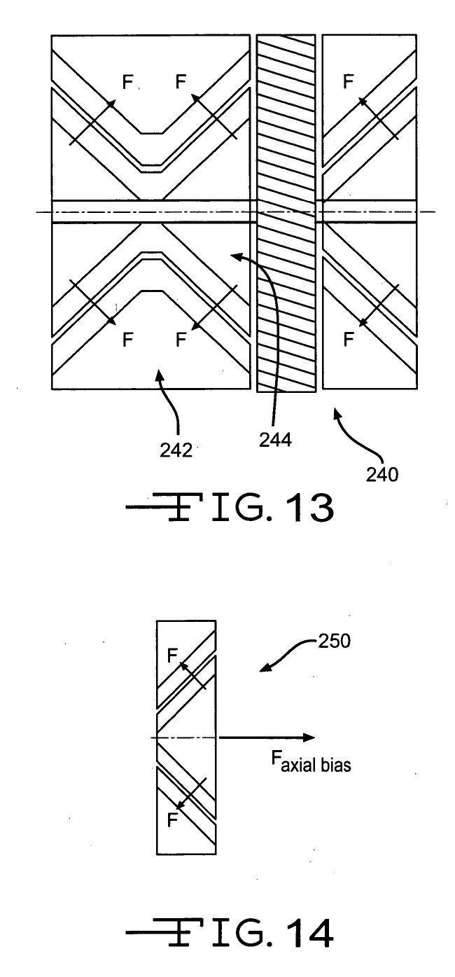

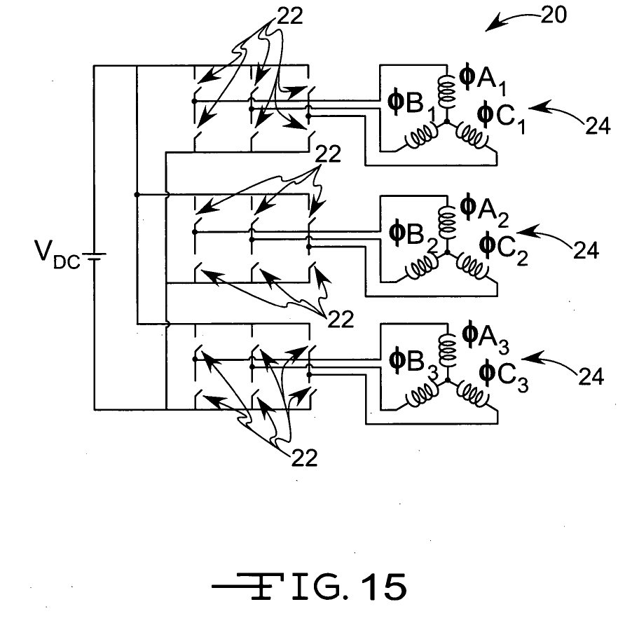

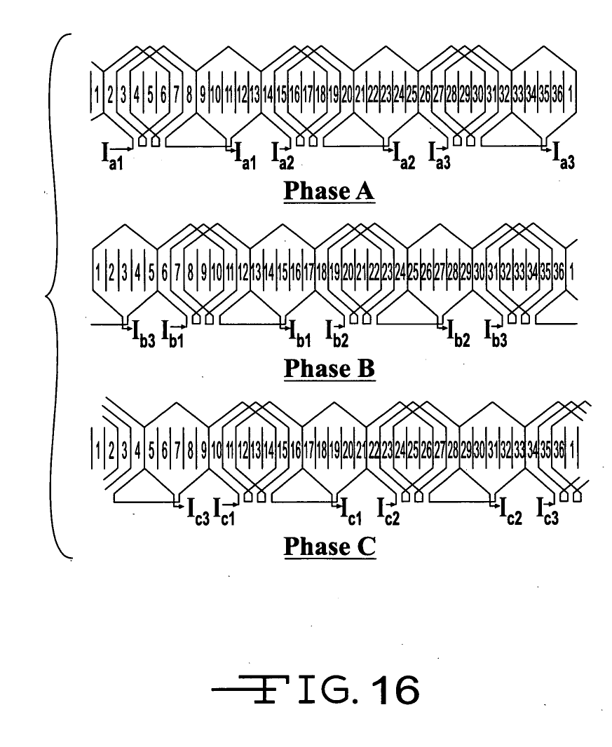

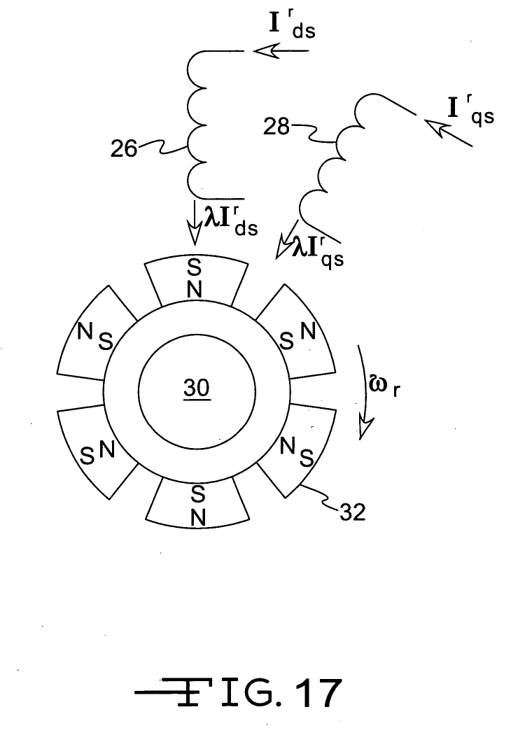

In a fourth embodiment of a bearingless machine 230, which is illustrated in FIG. 12, a pair of rotatable parts 162 are supported for rotation within a pair of stationary parts 164, similar to the second embodiment of the bearingless machine 210 describe above. However, these rotatable parts 162 and stationary parts 164 are tapered in opposing directions to the rotatable parts 132 and stationary parts 134 in the second embodiment of the bearingless machine 210.

It should be appreciated that the bearingless machines described above are provided for illustrated purposes. Though two rotatable parts and two stationary parts are described as pairs, the rotatable parts can be integrally formed to form a one-piece rotor 242, as illustrated in the bearingless machine 240 in FIG. 13. Similarly, the stationary parts can be integrally formed to form a one-piece stator 244. Moreover, the bearingless machines are not limited to include a single conical bearingless motor/generator or two conical bearingless motor/generators; but instead may include any number of conical bearingless motor/generators, such as the three conical bearingless motor/generators shown.

It should be clearly understood that the rotatable parts may be supported within the stationary parts, or about the stationary parts. The rotatable parts and stationary parts may be tapered in either direction, as illustrated by comparing FIGS. 8 and 10 with FIGS. 11 and 12, respectively. The rotatable parts may or may not include a hard magnetic structure 122. Any suitable winding configuration may be used for carrying out the invention, and the invention may be practiced with any suitable control scheme. The force F exerted on the rotatable parts may be an attractive force or a repulsive force. Moreover, the force F may be directed orthogonal to any angle α, which is greater than 0° and less than 90° relative to the axis of rotation A of the rotatable parts, wherein the angle α is dependent upon the application of the bearingless machine.

It should further be understood that the conical bearingless motor/generators described and shown could function as either a conical bearingless motor or generator. For example, the bearingless machine 100 described above and illustrated in FIGS. 7 and 8 is in the form of flywheel storage system, wherein the conical bearingless motor/generator 110 is adapted to function as a motor to transfer energy from the stationary part 114 to the rotatable part 112 and further as a generator to transfer energy from the rotatable part 112 to the stationary part 114. The energy from the rotatable part 112 can be converted to electrical energy, which may be used as a power source for electrical components.

It should be appreciated that a bearingless machine 250 may have a single conical bearingless motor/generator, as illustrated in FIG. 14. The bearingless machine 250 may in the form of a pump, which is adapted to move liquid, wherein the liquid (i.e., a fluid force) provides an axial bias force F_{axial bias}. Alternatively, the bearingless machine 250 may be in the form of a turbine engine, wherein gas (i.e., another fluid force) provides an axial bias force F_{axial bias}. As yet another alternative, a single bearingless motor/generator may be used in conjunction with a mechanical bearing (not shown), wherein the mechanical bearing is adapted to provide an axial bias force Fₐₓᵢₐₗ bias (i.e., a mechanical force). Alternatively, a single conical bearingless motor/generator may be used in conjunction with a pivot for holding the rotor, wherein the axial bias force F_{axial bias} is again a mechanical force. An axial magnetic bearing (MB) may act on (e.g., via magnetic force) a single conical bearingless motor/generator. The magnetic force may be passive (e.g., through the use of permanent magnets) or active. Similarly, a radial magnetic bearing, which has some centering force, may be used with a single conical bearingless motor/generator. As yet another alternative, a single conical bearingless motor/generator may be oriented such that the weight of the rotatable part (i.e., gravitational force) holds the rotatable part in place (i.e., provides an axial bias force F_{axial bias}).

It should further be appreciated that one or more conical bearingless motor/generators may be used solely to produce an electromagnetic suspension system, without transferring energy. In this case, the conical bearingless motor/generators may have one or more windings for producing only a control field, which is adapted to exert a force on the rotatable part to levitate the rotating part with respect to the stationary part. As stated above, the winding is oriented so that the force is directed at an angle, which is greater than 0° and less than 90° relative to the axis of rotation of the rotatable part. In this way, the control field can axially and radially levitate the rotatable part.

It should be appreciated that the terms “soft magnetic”, as used throughout the description, should be understood to mean ferromagnetic. It should also be appreciated that a back iron is not required for practicing the invention. For example, the invention could be practiced as an air core motor. Moreover, teeth 126 and slots 128 are not required for practicing the invention. Further, is should be understood that the invention is not limited to be practiced as a permanent magnetic motor/generator but may be practiced as an inductive motor, a synchronous reluctance motor, a switched reluctance motor, or in other types of motor/generators that the invention may be well suited.

Now with reference to FIG. 15, there is illustrated a cylindrical motor control system 20 for an electromagnetic rotary drive for use in a cylindrical bearingless motor-generator (hereinafter “motor”). It should be noted that the standard motor drive control system described above has only six switches 12, while the control system 20 shown in FIG. 15 has eighteen switches 22. As a consequence, the control system 20 can stimulate three systems of three phases. Each of these systems comprises a pole pair system, generally indicated at 24, resulting in three pole pair systems. Although there are three times as many switches, the required power rating for each switch 22 is much smaller than that for the conventional control system 10 described above. For example, if the number of turns in the motor is kept constant, the voltage the switches 22 would be required to block would be one third of the normal system voltage of the conventional control system 10. If the motor is required to have the same bus voltage as the conventional control system 10, the number of winding turns could be increased and the switches 22 would only carry one third the normal current of the conventional control system 10. In addition, the new control system 20 provides fault tolerance. If any of the coils in the new control system 20 or the power electronics for a pole pair system 24 fails, the other two three-phase systems will still be able to provide motor torque and magnetic bearing forces.

A winding configuration with individually stimulated pole pairs is shown in FIG. 16. In this winding configuration, phase currents iₐ₁, iₐ₂, iₐ₃, i_{b1}, i_{b2}, i_{b3}, i_{c1}, i_{c2}, i_{c3} are defined in the three pole pairs 24 shown in FIG. 15. These are essentially three three-phase systems. The first system contains phase currents iₐ₁, i_{b1}, and i_{c1}. This system can be transformed into a rotor reference frame with known transformations, as follows:

$$[ \begin{matrix}{i}_{qs 1}^{r} \\ {i}_{ds 1}^{r} \\ {i}_{01}\end{matrix} ] = [ \begin{matrix}cos {θ}_{r} & cos ( {θ}_{r} - \frac{2 π}{3} ) & cos ( {θ}_{r} + \frac{2 π}{3} ) \\ sin {θ}_{r} & sin ( {θ}_{r} - \frac{2 π}{3} ) & sin ( {θ}_{r} + \frac{2 π}{3} ) \\ \frac{1}{2} & \frac{1}{2} & \frac{1}{2}\end{matrix} ] [ \begin{matrix}{i}_{a 1} \\ {i}_{b 1} \\ {i}_{c 1}\end{matrix} ] \qquad ( 1 )$$

FIG. 17 shows fictional coils (illustrating the manner in which the three three-phase systems operate), generally indicated at 26, 28, which rotate with the rotor 30 representing the rotor reference frame q and d-axis currents. It should be noted that the rotor reference frame d-axis current produces no average torque and the rotor reference frame q-axis current produces torque.

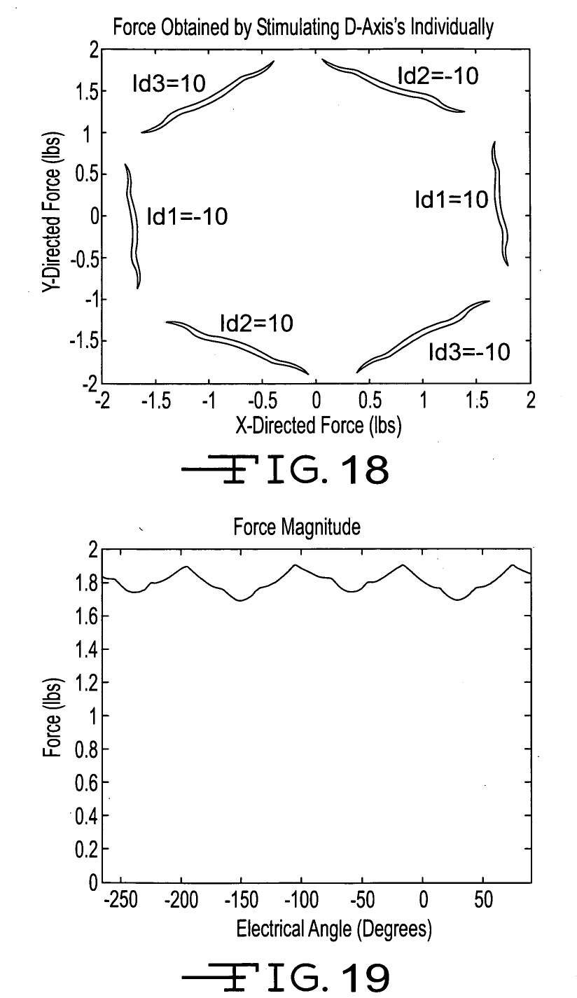

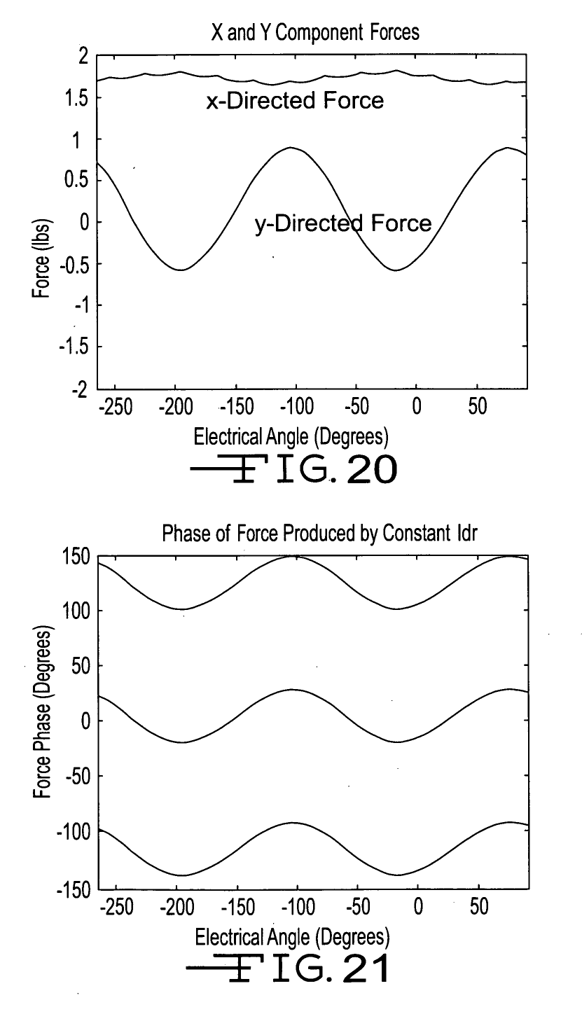

Note that while the d-axis current produces no torque, it does produce a lateral force. It should be noted what happens if the rotor reference frame d-axis currents are permitted to be different in the three different three-phase pole pairs 24, while keeping the rotor reference frame q-axis currents the same. FIG. 18 shows the force produced on the rotor 30 when 10 amps (first positive, then negative) is applied individually to each of the pole pairs 24 of the rotor reference frame d-axes while the other pole pairs have zero rotor reference frame d-axis and q-axis currents. FIG. 19 shows the magnitude of the force on the rotor 30 with i_{ds1}^{r}=+10 A, and the rest of the rotor reference frame d-axis and q-axis currents set to zero. This force has an average value of 1.8 lbs. This force has a strong fourth harmonic ripple, and also a much smaller second harmonic component. The rotor force components in the x and y directions, which are plotted in FIG. 20, each have second harmonic ripples, and combine to generate the fourth harmonic ripple in the force.

The above results demonstrate that the forces generated by the rotor reference frame d-axis current i_{ds}^{r} have fairly constant magnitudes. The force phases generated on the rotor using constant d-axis currents are plotted in FIG. 21. Note that this Figure plots the phases of the force in mechanical degrees versus the electrical angle of the motor. The phases of the rotor forces generated by exciting separate rotational reference frame d-axis currents are 120 mechanical degrees apart from each other, and vary 46 mechanical degrees (+/−23 mechanical degrees) over an electrical revolution.

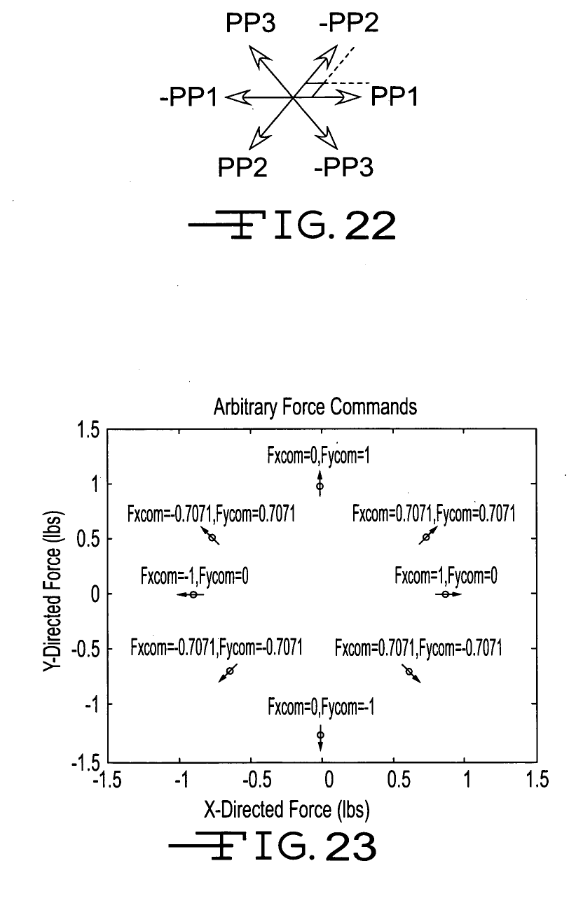

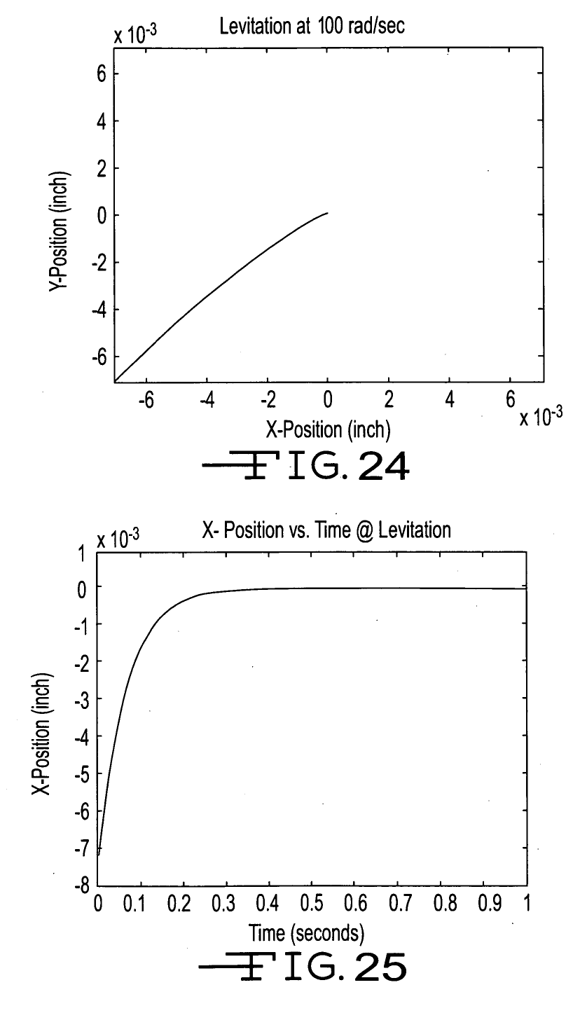

FIG. 22 shows the force vectors PP1, −PP1, PP2, −PP2, PP3, −PP3 that are possible with the different pole pairs 24. There are six possible force directions, using the positive and negative rotational reference frame d-axis currents. These forces bound six distinct regions. A desired force within any region can be produced optimally by using the vectors bordering that region as the basis. From this, a control system can be developed.

First, the phases of the six force vectors PP1, −PP1, PP2, −PP2, PP3, −PP3 need to be determined. By fitting the results in FIG. 21, the force phase β is calculated for each of the six force vectors PP1, −PP1, PP2, −PP2, PP3, −PP3 as a function of electrical angle of the rotor θᵣ:

$$\begin{matrix}{β}_{1} = 4.3050 + 23.155 \cdot cos ( 2 \cdot ( {θ}_{r} + 105 ) \frac{π}{180} ) & ( 2 ) \\ {β}_{1 - negative} = {β}_{1} + 180 & ( 3 ) \\ {β}_{2} = {β}_{1} - 120 & ( 4 ) \\ {β}_{2 - negative} = {β}_{2} + 180 & ( 5 ) \\ {β}_{3} = {β}_{1} + 120 & ( 6 ) \\ {β}_{3 - negative} = {β}_{3} + 180 & ( 7 )\end{matrix}$$

During rotor levitation, the phase of the desired force is calculated and compared with the six available force vectors PP1, −PP1, PP2, −PP2, PP3, −PP3, and the two force vectors that border the region containing the desired force are then chosen as the basis. Next, the desired force is transformed from the x, y basis to the basis containing the phase of the two vectors to be used, β_{boundary-1}, and β_{boundary-2}. The transformation is performed using the following matrix:

$$P = [ \begin{matrix}real ( {ⅇ}^{j \cdot {β}_{boundary - 1} \cdot \frac{180}{π}} ) & real ( {ⅇ}^{j \cdot {β}_{boundary - 2} \cdot \frac{180}{π}} ) \\ imag ( {ⅇ}^{j \cdot {β}_{boundary - 1} \cdot \frac{180}{π}} ) & imag ( {ⅇ}^{j \cdot {β}_{boundary - 2} \cdot \frac{180}{π}} )\end{matrix} ] \qquad ( 8 )$$

This allows the two currents that make up the boundary to the region, i_{ds-boundary1}^{r}, i_{ds-boundary2}^{r}, to be defined as follows.

$$[ \begin{matrix}{i}_{ds - boundary 1}^{r} \\ {i}_{ds - boundary 2}^{r}\end{matrix} ] = {P}^{- 1} \cdot [ \begin{matrix}\frac{{F}_{x - com}}{currentstiffness} \\ \frac{{F}_{y - com}}{currentstiffness}\end{matrix} ] \qquad ( 9 )$$

where F_{x-com} and F_{y-com} are magnetic force bearing commands and current stiffness is a constant that determines the amount of force delivered to the rotor for 1 amp of current, in this case it is 0.18 lbs/A (per FIG. 19). This technique is used to generate various force commands; the results can be seen in FIG. 23. It should be noted that there may be some ripple in the force. This may be expected, as no attempt is made to reduce the natural ripple inherent to constant d-axis rotor reference frame current.

Now, a mechanical model of the rotor 30 is generated, with motor torques and forces as inputs, and the rotor angle, speed, lateral position and lateral velocity as outputs. This motor rotor is a mass which is free to move in the x and y directions, and begin by defining the following complex quantities:
x₁=Posₓ+i·Pos_{y}
x₂=Velₓ+i·Vel_{y}
where x₁ and x₂ are system states defining rotor lateral position and velocity, i is imaginary number, Posₓ and Pos_{y} are x and y rotor positions in inches, and Velₓ and Vel_{y} are x and y rotor positions in meters per second.

From Newton's second law:
F=ma=m·\dot{x}₂
where F is force in Newtons, m is mass in kilograms.

With this information, the system can be described as follows:

$$[ \begin{matrix}{\dot{x}}_{1} \\ {\dot{x}}_{2}\end{matrix} ] = [ \begin{matrix}0 & 1 \\ 0 & 0\end{matrix} ] [ \begin{matrix}{x}_{1} \\ {x}_{2}\end{matrix} ] + [ \begin{matrix}0 \\ \frac{1}{m}\end{matrix} ] F = A [ \begin{matrix}{x}_{1} \\ {x}_{2}\end{matrix} ] + BF \qquad ( 10 )$$

where A and B are linear state space description matrices.

Note that the controllability matrix C of this system is:

$$C = [ \begin{matrix}B & A \cdot B\end{matrix} ] = [ \begin{matrix}0 & \frac{1}{m} \\ \frac{1}{m} & 0\end{matrix} ] \qquad ( 11 )$$

This matrix has full rank so the system is controllable. Now, angular quantities are defined as follows:
x₃=θ_{mechanical}
x₄\overline{ω}_{mechanical}
where x₃ and x₄ are angular position and velocity, θ_{mechanical} is the mechanical angle of the rotor in radians, and ω_{mechanical} is mechanical speed in radians per second.

With these quantities, the angular system can be described as:

$$[ \begin{matrix}{\dot{x}}_{3} \\ {\dot{x}}_{4}\end{matrix} ] = [ \begin{matrix}0 & 1 \\ 0 & 0\end{matrix} ] [ \begin{matrix}{x}_{3} \\ {x}_{4}\end{matrix} ] + [ \begin{matrix}0 \\ \frac{1}{J}\end{matrix} ] T \qquad ( 12 )$$

where J is rotational inertia and T is torque in newton-meters.

The controllability matrix C of this system is:

$$C = [ \begin{matrix}B & A \cdot B\end{matrix} ] = [ \begin{matrix}0 & \frac{1}{J} \\ \frac{1}{J} & 0\end{matrix} ] \qquad ( 13 )$$

The controllability matrix is again full rank, thus the system is controllable.

Now the position of the rotor can be described using the differential equations above along with the calculated torques and forces.

As was mentioned previously, motor torque will be controlled by enforcing the same appropriate rotor reference frame q-axis currents i_{qs}^{r} on all three pole pair systems. Also, it has been demonstrated that any desired radial force can be obtained by correctly controlling the rotational reference frame d-axis currents in the individual pole pairs 24. Using the results above, a rudimentary magnetic bearing controller can be designed to levitate the rotor 30; the position will be controlled with a proportional derivative (PD) controller (not shown). The controller has negative stiffness compensation, which essentially cancels the negative stiffness due to the motor permanent magnets (PMs). This controller outputs a force command, which is broken down into three pole pair rotor reference frame d-axis currents i_{ds1}^{r}, i_{ds2}^{r}, i_{ds3}^{r}. The motor may have mechanical touchdown bearings (not shown) which prevent the rotor 30 from contacting the lamination stacks of the stator 32 (see FIG. 17); they limit rotor motion to within 10 mils of center. On startup, the rotor 30 will be resting on these bearings, thus, the rotor will be levitated from the starting point on the touchdown bearing. Obviously these dimensions are dependent on the physical characteristics of the motor.

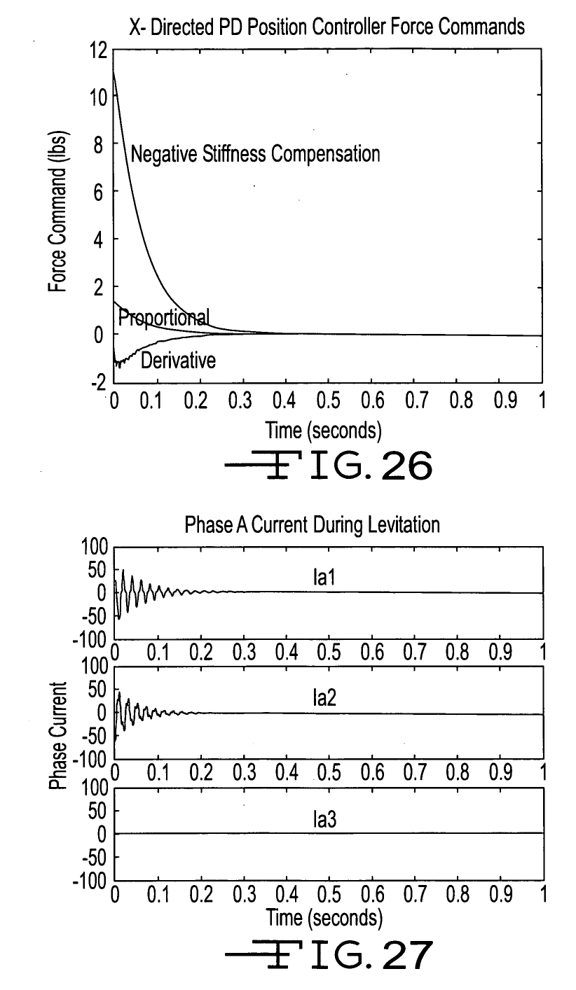

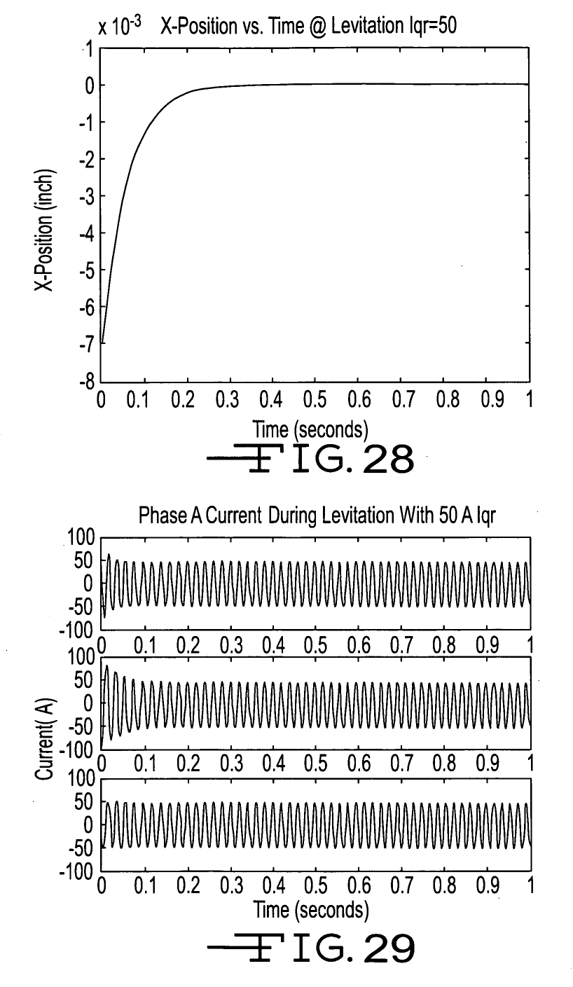

When the controller is implemented, the rotor 30 is levitated off of the touchdown bearing with an initial speed, such as 100 radians per second, and a torque command, which in this example is zero (thus i_{qs}^{r}=0 for all three systems). FIG. 24 shows the x, y plot of the rotor during this levitation, and FIG. 25 shows the x-component of position versus time during the levitation. FIG. 26 shows the PD force command separated into the negative stiffness compensation, proportional gain, and derivative components. The phase currents during this levitation period are seen in FIG. 27. The currents can be fairly high when the rotor 30 is being pulled off the back up bearings but the currents should decrease dramatically as time increases, and the rotor approaches the center. Rotor imbalance and sensor noise are present in the system, and some amount of current will be required to hold the rotor 30 in the center of the touchdown bearing. The rotor 30 may be intentionally rotated around its center of mass instead of its geometric center, which minimizes levitation currents, although in this case the position will not necessarily be forced to center.

In order to show that this control system provides simultaneous motor and magnetic bearing action, levitation is repeated, this time with 50 A of rotor reference frame q-axis current. The x position during this levitation is plotted in FIG. 28. This figure shows that the time response of levitation does not appreciably change with motoring current.

The phase currents present while levitating with 50 A I_{qa}^{r} are shown in FIG. 29. The peak current of 95 A is achieved briefly during levitation in Iₐ₂. The maximum current reached during the levitation period with no I_{qs}^{r} is 61 A, also in Iₐ₂. So, it is apparent that for a particular force level, the motor should be de-rated from its maximum power level. However, in this example, the magnetic bearing function needs a large force only during levitation, to overcome the negative stiffness while lifting the rotor 30 off of the back-up bearing. If this is the only time a large amount of current is required, temporarily exceeding the maximum phase limit of the motor will not be a problem, since the excess current will be present for such a brief period that no appreciable wire heating will occur. Actually, during most applications, levitation will occur before motoring starts, so the added current requirement may not exist at all.

The relevant factor to be considered when selecting ratings is the force needed to levitate the rotor. This involves factors that are not considered, including sensor noise, shaft runout, and rotor imbalance. In addition to compensating for these factors, if the motor is used as a flywheel in a satellite, it may be necessary to levitate the rotor on earth before sending it to orbit, which would require that the bearing system be able to support the weight of the rotor 30. Furthermore, the motor may be used to provide attitude control of the satellite in addition to energy storage. In this application, the magnetic bearing should be able to keep the rotor 30 levitated while the spacecraft is rotated.

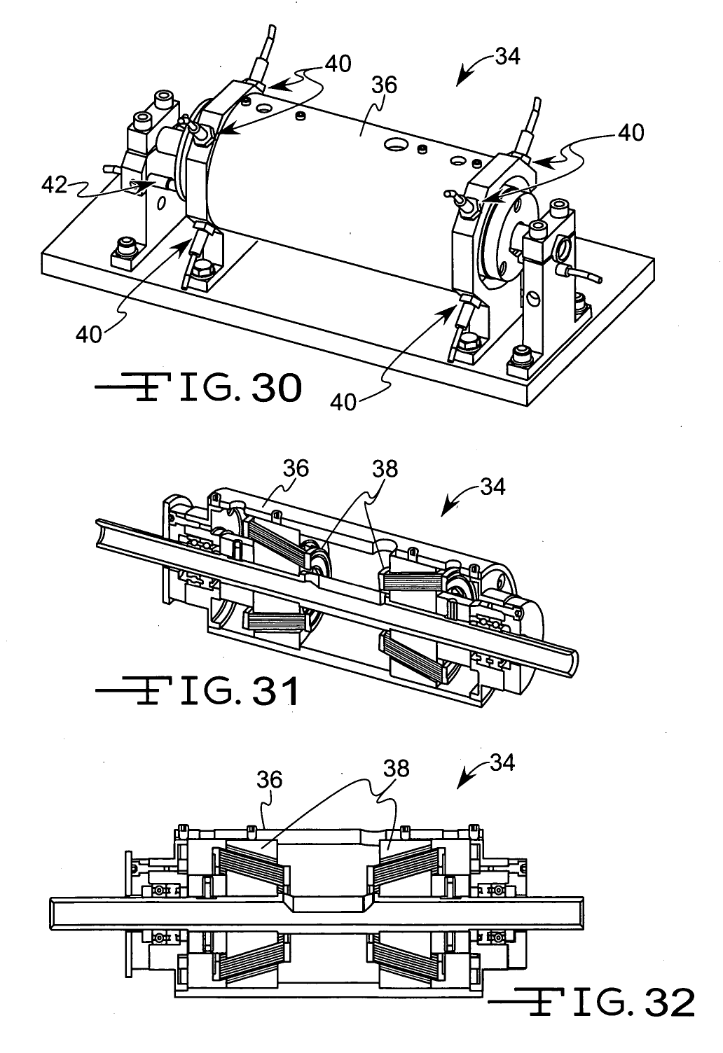

Two conical motors, wound with three separated pole pairs, can be used together with the aforementioned control system to fully levitate and spin a rotor. An example of a machine 34 having two such conical motors is shown in FIGS. 30-32. In the illustrated embodiment of the machine 34, a rotor 36 rotates on the outside of stators 38, although a machine may be configured with rotors that rotate on the inside of the stators. Information on the position of the rotor 36 is received by a controller with eight radial eddy current sensors 40 and four axial eddy current sensors 42.

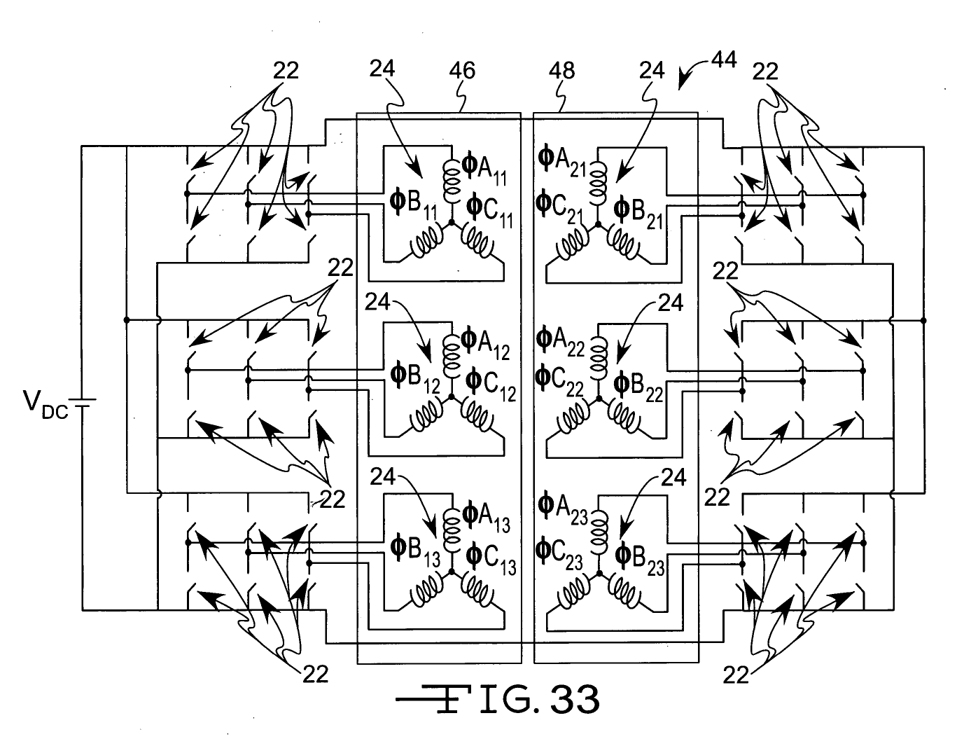

An exemplary control system 44 for driving the two conical motors is shown in FIG. 33. One conical motor comprises windings 46 comprised of three three-phase pole pair systems 24. The other conical motor comprises windings 48 also comprised of three three-phase pole systems 24. One advantage of this type of motor drive control system is that it provides fault tolerance; if any switch 22 or pole pair system 24 fails, the other two three-phase systems 24 will still provide rotation and levitation forces.

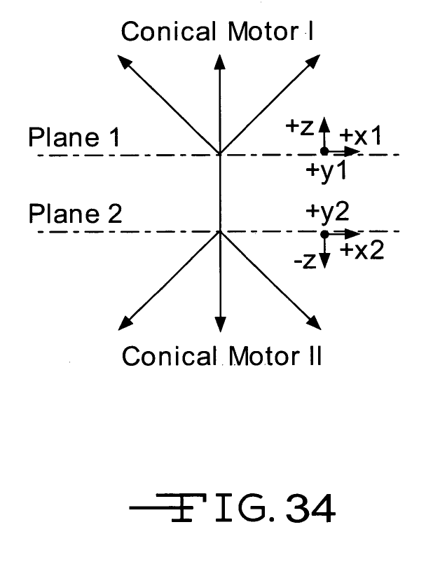

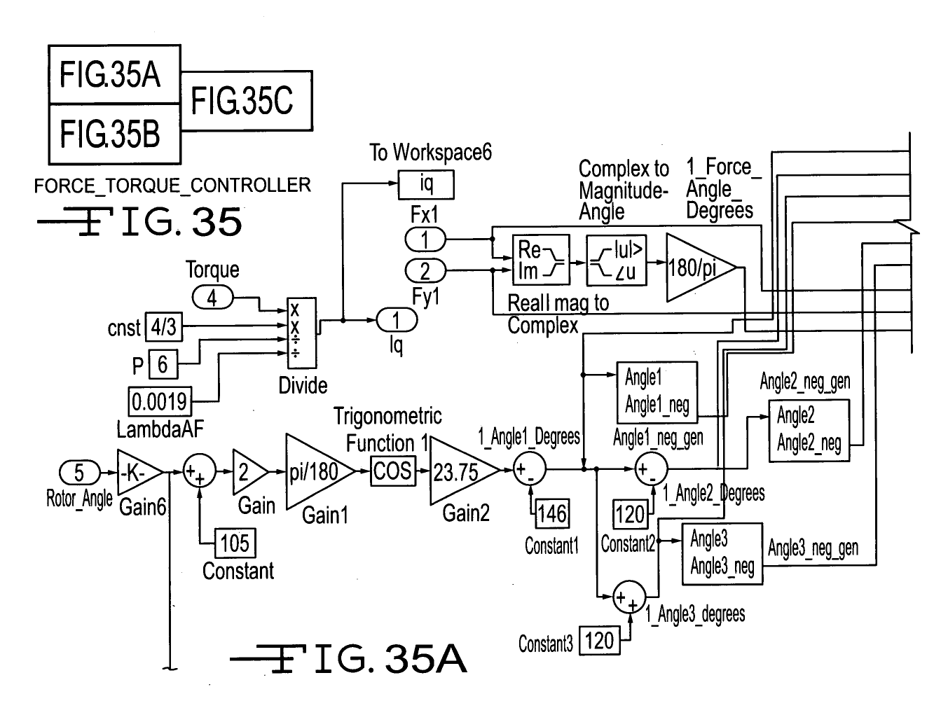

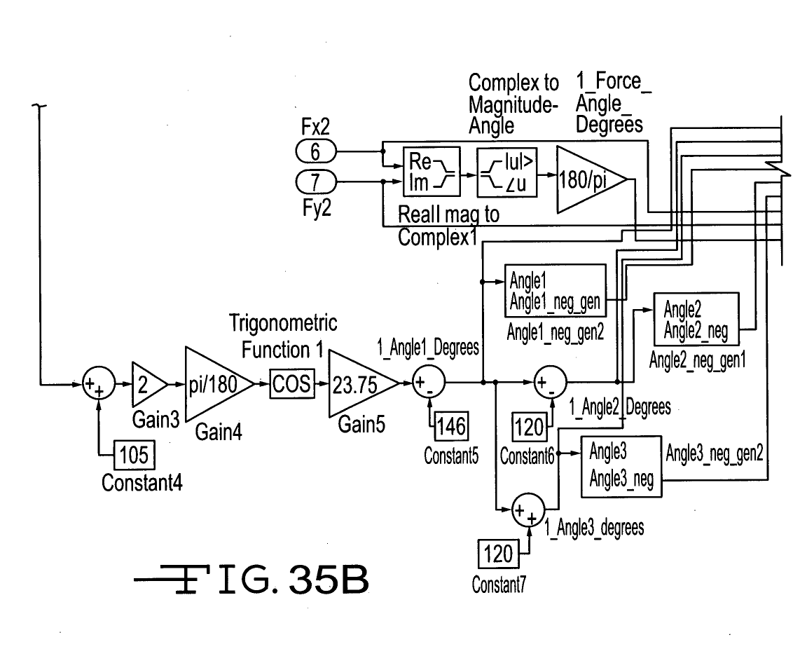

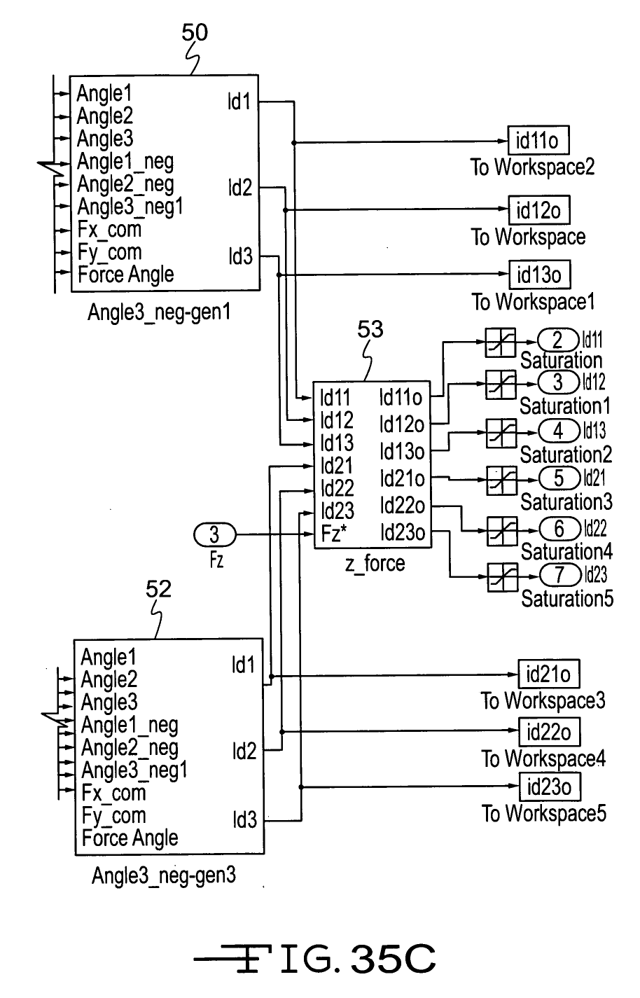

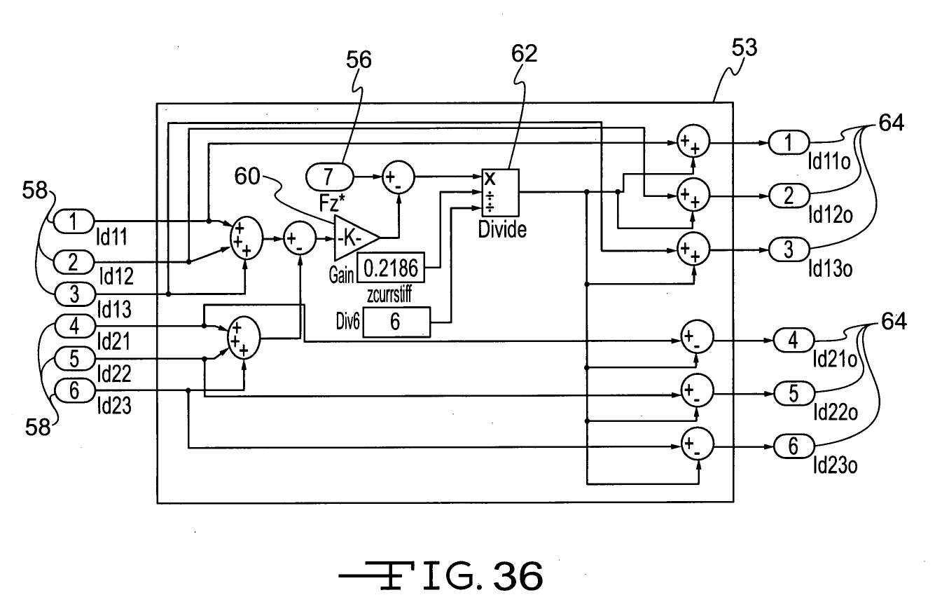

FIG. 34 shows the force vectors that are possible with the different pole pair systems 24. There are six force vectors that have an axial component as well as a radial component.

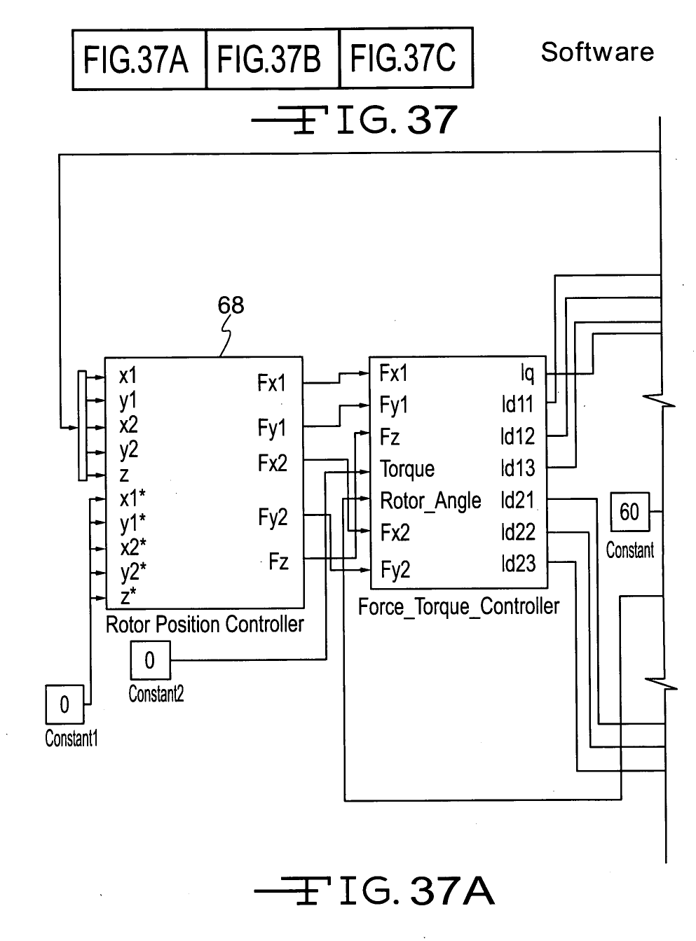

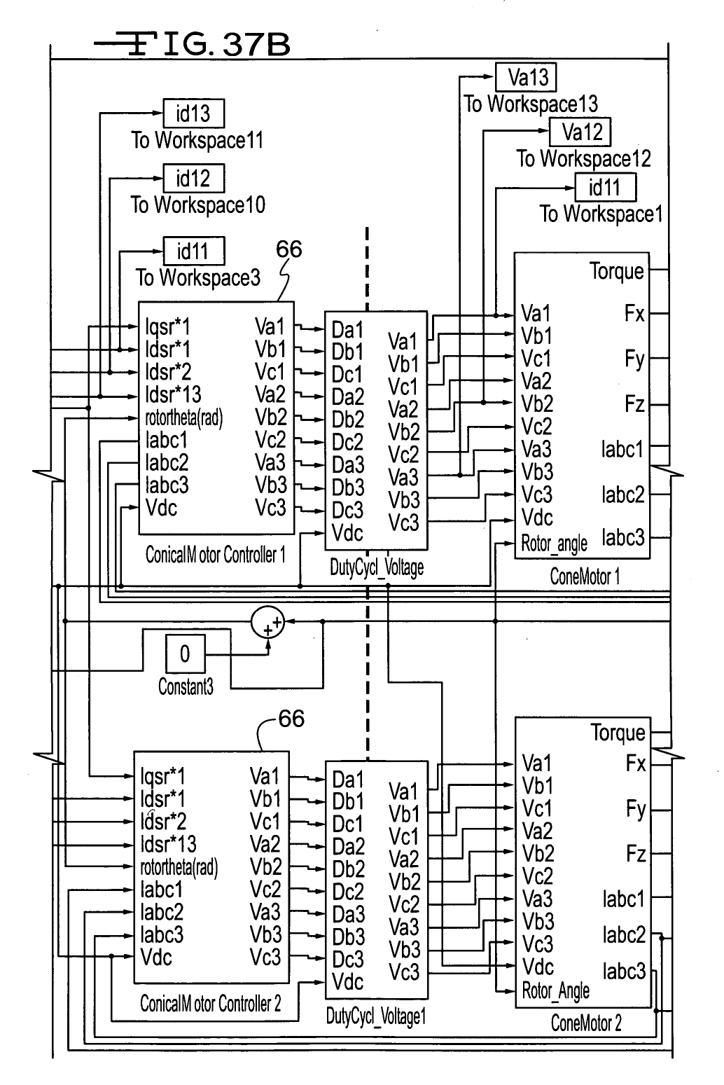

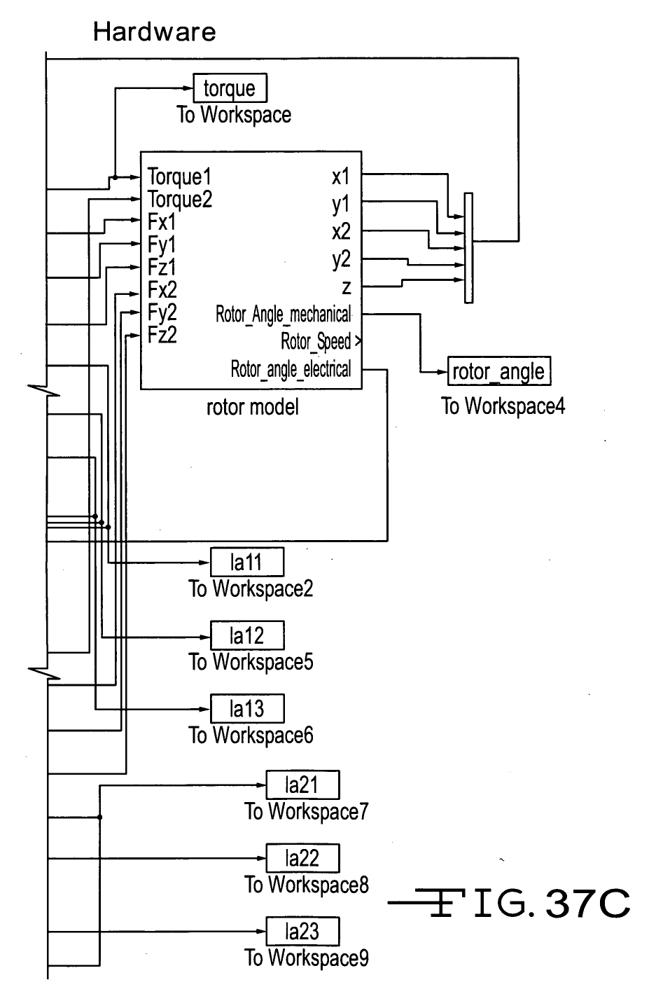

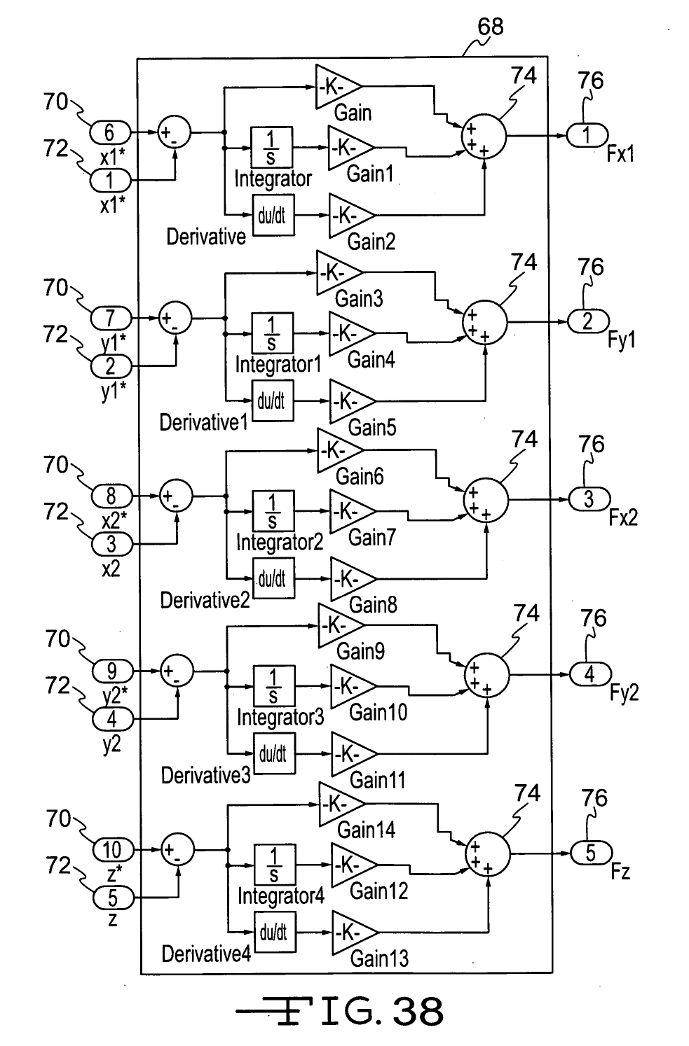

FIG. 35 shows a schematic force and torque control code. Radial force control blocks 50, 52 use a radial control technique, as discussed above in connection with the cylindrical motor control system. The conical motor essentially reduces the current stiffness, as compared to that required by a similarly sized cylindrical motor, since all of the magnitude of force is no longer directed radially. The radial force control block 50 controls the radial force applied to Plane 1, while the radial force control block 52 controls the force applied to Plane 2. A new control block 53 is introduced to control the axial force. FIG. 36 shows a schematic of this control block 53. The inputs to this control block 53 are the axial force command at 56 and the rotor reference frame d-axis current commands, which were generated with the radial force control blocks 50 and 52, at 58. Axial force is created when the total force acting on Plane 1 is different than the total force acting on Plane 2. Thus, if one plane is creating a large radial force, it will have the effect of creating some axial force. However, the resultant axial force can be compensated for by adding equal parts of d-axis current to all of the pole pair systems 24 on the other motor. The axial force created by the radial controllers is calculated by taking the sum of the rotor reference frame d-axis current commands from the radial controller at Plane 1 minus the sum of the rotor reference frame d-axis current commands from the radial controller at Plane 2, then multiplying by the current stiffness at 60. This calculated axial force is then simply subtracted from the commanded axial force. This value, calculated at 62, is added to the rotor reference frame d-axis current commands of Motor I (shown in FIG. 34) and subtracted from the rotor reference frame d-axis current commands of Motor II. The final rotor reference frame d-axis current commands at 64 are sent out of this axial force control block 53 to the standard rotor reference frame current regulators 66 in FIG. 37.

A rotor position controller 68 in FIG. 37 receives position information from the sensors 40, 42 and outputs force commands necessary to maintain levitation. FIG. 38 shows one implementation of the position controller as a proportional-integral-derivative (PID) controller. Note that while this specific example uses a PID controller, any other suitable controller type can be used, as well. The commanded position is input at 70, while measured position is input at 72. A standard PID control loop is executed at 74. Force commands at 76 are the output of this block 68.

The present invention is not intended to be limited to the control system described above. Similarly, the present invention is not intended to be limited to any particular winding configuration. It should be appreciated that any suitable winding configuration may be used for carrying out the invention.

The aforementioned invention is not intended to be limited to the motor described above but can be used on other motors with six or more poles. Motors with which the invention can be used include, but are not limited to, induction motors, synchronous reluctance motors, and permanent magnet motors. The motors may be configured as cylindrical or conical, interior rotor/exterior stator, or exterior rotor/interior stator.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A conical bearingless motor/generator comprising:
a rotatable part having an axis of rotation; and
a stationary part having one or more windings each producing both a drive field and a control field, the drive field being operable to exert a torque on the rotatable part that transfers energy between the rotatable part and the stationary part, the control field is operable to exert a force on the rotatable part to levitate the rotatable part, the force being directed at an angle greater than 0° and less than 90° relative to the axis of rotation of the rotatable part.

2. The conical bearingless motor/generator according to claim 1 wherein the rotatable part is adapted to be rotated within the stationary part.

3. The conical bearingless motor/generator according to claim 1 wherein the rotatable part is adapted to be rotated about the stationary part.

4. The conical bearingless motor/generator according to claim 1 wherein the rotatable part includes a soft magnetic and/or non-magnetic structure and a hard magnetic structure.

5. The conical bearingless motor/generator according to claim 4 wherein the soft magnetic and/or non-magnetic structure includes a back iron.

6. The conical bearingless motor/generator according to claim 4 wherein the hard magnetic structure is a permanent magnet.

7. The conical bearingless motor/generator according to claim 6 wherein hard magnetic structure is supported about the rotatable part with a retaining material.

8. The conical bearingless motor/generator according to claim 7 wherein the retaining material is a carbon material wrapped about the rotatable part and the hard magnetic structure to hold the hard magnetic structure in place relative to the rotatable part as the rotatable part is rotated.

9. The conical bearingless motor/generator according to claim 1 wherein the stationary part may include a soft magnetic and/or non-magnetic structure for supporting the winding.

10. The conical bearingless motor/generator according to claim 9 wherein the soft magnetic and/or non-magnetic structure includes a back iron.

11. The conical bearingless motor/generator according to claim 1 wherein the stationary part is provided with teeth and slots for supporting the winding.

12. The conical bearingless motor/generator according to claim 1 wherein the winding is affixed to the stationary part.

13. The conical bearingless motor/generator according to claim 1 wherein the winding is affixed to the stationary part with epoxy.

14. The conical bearingless motor/generator according to claim 1 wherein the force is an attractive force that pulls the rotatable part in the direction of the stationary part.

15. The conical bearingless motor/generator according to claim 1 wherein the force is a repulsive force that pushes the rotatable part in a direction away from the stationary part.

16. The conical bearingless motor/generator according to claim 1 wherein the winding is controlled by a control scheme.

17. The conical bearingless motor/generator according to claim 1 wherein rotatable part is adapted to store and discharge kinetic energy.

18. A conical bearingless motor/generator comprising:
a stationary part; and
a rotatable part, the stationary part and the rotatable part having an axis of rotation such that the combination of the stationary part and the rotatable part form a minimum of three pole pairs, the stationary part having one multi-phase winding per pole pair capable of providing both a torque on the rotatable part and a force on the rotatable part to levitate the rotatable part.

19. The conical bearingless motor/generator according to claim 18 wherein the force is directed at an angle greater than 0° and less than 90° relative to the axis of rotation of the rotatable part.
